(19) United States
(12) Patent Application Publication
(10) Pub. No.: US 2025/0301248 A1
(43) Pub. Date: Sep. 25, 2025

(54) SMART WATCH

(71) Applicant: Shenzhen Diewei Technology Co., Ltd., Shenzhen (CN)

(72) Inventor: Linwei LI, Shenzhen (CN)

(73) Assignee: Shenzhen Diewei Technology Co., Ltd., Shenzhen (CN)

(21) Appl. No.: 19/089,063

(22) Filed: Mar. 25, 2025

(30) Foreign Application Priority Data
Mar. 25, 2024 (CN) 202420584763.4

(51) Int. Cl. H04R 1/02; G06F 1/16

(52) U.S. Cl. CPC H04R 1/028; G06F 1/163; H04R 1/025; H04R 1/026; H04R 2499/15

(57) ABSTRACT

The present disclosure provides a smart watch that relates to the field of smart wearable devices. The smart watch includes a watch body and two earphones, the watch body including a watch dial and two watch straps connected to the watch dial; the watch dial includes two installation grooves formed on a circumferential side thereof so that the two earphones are respectively inserted into the two installation grooves and extend out of the two installation grooves. Each of the two earphones includes a magnetic female connector, and a controller and a magnetic male connector connected to the magnetic female connector are arranged inside the watch dial. The magnetic male connector and the magnetic female connector are stably connected with each other through a magnetic adsorption way. The present disclosure is configured to enhance user experiences by optimizing an access method of the two earphones thereof.

### CROSS-REFERENCE TO RELATED APPLICATION

This application claims the benefit of priority from Chinese Patent Application No. 202420584763.4 entitled “SMART WATCH” and filed on Mar. 25, 2024, the content of which is hereby incorporated by reference in its entire by reference.

### BACKGROUND

### Technical Field

The present disclosure generally relates to the field of intelligent wearable devices, and especially relates to a smart watch.

### Description of Related Art

With the development of technologies and increasing demands for smart wearable devices from consumers, smart watches, as portable electronic devices that integrate with time display, health monitoring, and communication and entertainment functions, have become key points of market competition in terms of design innovations and user experience optimization. Conventional watches and early designs of smart watches often overlook convenience requirements of users in daily usage, especially in configuration and access of audio output devices such as earphones, while pursuing functional integration.

A common design of the watch in the market is that the earphone is usually taken as an additional accessory and integrated into a watch body of the watch through a specific storage component. Such storage component often uses a rotation lid structure, so that it needs to perform a rotation action to open the lid before the earphone can be put into the watch or taken out of the watch. Although this type of design to some extent ensures a safety of the earphone and an overall aesthetics of the watch. However, in an actual usage, a frequent rotation that the lid is opened and closed can be tedious and time-consuming, especially in emergency situations such as answering calls or listening to music, such inconvenience is particularly prominent, resulting in reducing smoothness and satisfaction of user experiences.

The above mentioned limitations of the conventional technologies are occurred, there is an urgent need in the market for a more convenient and efficient access solution of the earphones that can maintain a compact design and an aesthetics of the watch, while significantly enhancing convenient experiences of users during using the earphones. Therefore, the present disclosure provides an improved design that the earphones are directly placed on a side of a watch dial, so as to simplify an access process of the earphone and allow users to directly retrieve the earphones without additional operations, thereby greatly improving usage convenience and efficiency. At the same time, it also provides new ideas and directions for designing smart watches.

### SUMMARY

The technical problems to be solved: in view of the shortcomings of the related art, the present disclosure provides a smart watch which can enhance user experiences by optimizing an access method of earphones thereof.

In order to solve the above objectives, a smart watch according to an embodiment of the present disclosure includes:
a watch body including a watch dial and two watch straps connected to the watch dial, two installation grooves arranged on a side of the watch dial;
two earphones respectively inserted into the two installation grooves and extending out of the two installation grooves; and wherein
each of the two earphones includes a magnetic female connector, wherein a controller and a magnetic male connector that is connected to the magnetic female connector are arranged inside the watch dial, and the magnetic male connector and the magnetic female connector are stably connected with each other through a magnetic adsorption way.

Wherein each of the two earphones includes a case, a rubber stopper connected to a side of the case that faces the installation groove, and a gripping block that is convenient to be gripped by users and installed on a side of the case that faces away from the installation groove, wherein the gripping block extends out of the installation groove.

Wherein the gripping block is cylindrical, and a plurality of protrusions is uniformly arranged on an outer circumference of the gripping block.

Wherein the case includes a first main portion and a second main portion connected to each other, both the first main portion and the second main portion extending from an outer circumference of the watch dial to a middle of the watch dial, wherein a length of the first main portion that extends from the outer circumference of the watch dial to the middle of the watch dial is greater than that of the second main portion that extends from the outer circumference of the watch dial to the middle of the watch dial.

Wherein each of the two installation grooves includes a first cavity and a second cavity interconnected with each other, the first cavity configured to receive the first main portion therein, and the second cavity configured to receive the second main portion therein.

Wherein the magnetic female connector is arranged inside the second main portion and extends out of the second main portion, while the magnetic male connector extends out of the second cavity and abuts against the magnetic female connector.

Wherein an electrocardiogram detection module is arranged within the watch dial and configured to contact skins of human bodies.

Wherein the watch dial includes a front housing and a back housing assembled to the front housing so that a first receiving room is formed between the front housing and the back housing and configured to receive the controller therein.

Wherein the watch dial further includes a knob, and a control switch arranged in the first receiving room and connected to the controller, wherein the knob is inserted from the outside of the front housing and the back housing into the first receiving room, and connected to the control switch.

Wherein a pair of first protruding ears is spaced apart on opposite sides of the front housing along a circumferential direction of the front housing, and the two watch straps are respectively connected to the pair of first protruding ears through a rotating shaft thereof.

Wherein each of the pair of first protruding ears includes a third cavity, and the back housing includes a second protruding ear arranged inside the third cavity.

Wherein the watch dial is square, and the two earphones are respectively arranged on opposite sides of the watch dial.

Wherein a strip is provided at a position where the gripping block is connected to the case, and configured to insert users' fingertips thereinto.

Wherein the watch dial further includes a bottom housing, a cover, a touch screen, a control board and a battery module, the bottom housing and the cover engaged with each other to form a second receiving room for accommodating all the touch screen, the control board and the battery module therein, wherein the control board is electrically connected to both the touch screen and the battery module.

A smart watch according to another embodiment of the present disclosure includes: a watch body including a base and two earphones installed on the base, and a flipping cover rotatably connected to the base; and wherein

the flipping cover includes a third receiving room configured to accommodate the watch body therein, and the flipping cover rotates relative to the watch body to close the two earphones into the third receiving room.

Wherein one end of the base is connected to one end of the flipping cover through a rotation shaft, and the other end of the base is fastened to the other end of the flipping cover.

Wherein the base includes a cover plate and a protruding shell, and two slots formed between the cover plate and the protruding shell and configured to receive the two earphones therein.

Wherein a periphery of the cover plate protrudes outwardly to form a positioning step thereof, and the positioning step covers on the third receiving room of the flipping cover.

Wherein the flipping cover includes a bottom wall and a flange surrounding around the bottom wall, wherein the bottom wall and the flange cooperatively form the third receiving room, a through-hole formed on the bottom wall, wherein the watch body further includes a display screen exposed from the through-hole to the outside.

The present disclosure provides the advantages as below: the present disclosure provides the smart watch that is equipped with two installation grooves on the circumferential side of the watch dial for placing the two earphones, and the two earphones are stably placed in the two installation grooves through a magnetic attraction way, which improves user experience by optimizing an access method of the earphones, and also provides a flip mode to hide the earphones inside the smart watch, so as to conveniently use the earphones by users.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic view of a smart watch in accordance with a first embodiment of the present disclosure.

FIG. 2 is similar to FIG. 1, but shown from another view.

FIG. 3 is an exploded, schematic view of the smart watch of FIG. 1.

FIG. 4 is similar to FIG. 3, but shown from another view.

FIG. 5 is a partial schematic view of a watch dial of the smart watch of FIG. 1.

FIG. 6 is a schematic view of a front housing and a back housing of the smart watch of FIG. 1.

FIG. 7 is a schematic view of an earphone of the smart watch of FIG. 1.

FIG. 8 is a schematic view of a smart watch in accordance with a second embodiment of the present disclosure.

FIG. 9 is an exploded, schematic view of FIG. 8.

FIG. 10 is a partial schematic view of an earphone of the smart watch of FIG. 8.

FIG. 11 is another exploded, schematic view of FIG. 8.

FIG. 12 is a schematic view of a smart watch in accordance with a third embodiment of the present disclosure, shown the smart swatch in a closed state.

FIG. 13 is similar to FIG. 12, but shown the smart swatch in an open state.

FIG. 14 is an exploded, schematic view of the smart watch of FIG. 12.

FIG. 15 is an exploded, schematic view of a watch body of the smart watch of FIG. 12.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described embodiments of the present disclosure, all other embodiments obtained by one of ordinary skill in the related art on the premise of no creative work are within the protection scope of the present disclosure.

It should also be noted that if terms such as directional indications of “up”, “down”, “left”, “right”, “front” and “back”, etc. are involved in the embodiments of the present disclosure, the directional indications are only used to explain a relative position relationship and a motion condition etc., between components in a specific posture. If the specific posture changes, the directional indications will also change accordingly. The terms used in the specification of the present disclosure are only for the purpose of describing specific embodiments without being intended to limit the present disclosure. As used in the description of the present disclosure and the appended claims, terms of “one”, “one” and “the” in a singular form are intended to include a plural form unless the context clearly indicates otherwise.

In addition, the terms such as “first” and “second” shown in the specification are only used to describe, but not indicated that the elements of the present disclosure is important or represented the amount of the elements. That is, the features limited by the terms of “first” and “second” may explicitly or implicitly include one or more features. It should also be further understood that the term “and/or” used in the description of the present disclosure refers to include three parallel schemes that it is taken “A and/or B” as an example, which includes an A scheme, or a B scheme, or both A and B schemes. In addition, technical solutions among various embodiments can be combined with each other, but it should be implemented for one of ordinary skill in the related art. When the combination of technical solutions is contradictory or impossible to be implemented, it should be considered that such combination of technical solutions does not exist and is not within the protection scope of the present disclosure.

A common design of the watch in the market is that the earphone is usually taken as an additional accessory and integrated into a watch body of the watch through a specific storage component. Such storage component often uses a rotation lid structure, so that it needs to perform a rotation action to open the lid before the earphone can be put into the watch or taken out of the watch. Although this type of design to some extent ensures a safety of the earphone and an overall aesthetics of the watch. However, in an actual usage, a frequent rotation that the lid is opened and closed can be tedious and time-consuming, especially in emergency situations such as answering calls or listening to music, such inconvenience is particularly prominent, resulting in reducing smoothness and satisfaction of user experiences.

The above mentioned limitations of the conventional technologies are occurred, there is an urgent need in the market for a more convenient and efficient access solution of the earphones that can maintain a compact design and an aesthetics of the watch, while significantly enhancing convenient experiences of users during using the earphones. Therefore, the present disclosure provides an improved smart watch to solve the above-mentioned problems.

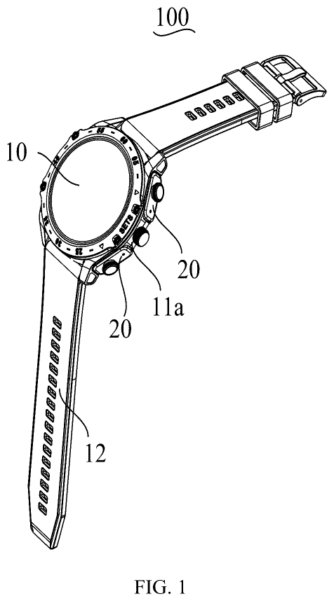

Referring to FIGS. 1-5, a smart watch according to a first embodiment of the present disclosure includes a watch body 10 and two earphones 20. The watch body 10 includes a watch dial 11 and two watch straps 12 connected to the watch dial 11, two installation grooves 11b arranged on a circumferential side 11a of the watch dial 11. The two watch straps 12 are respectively inserted into the two installation grooves 11b and extending out of the two installation grooves 11b. Each of the two earphones 20 includes a magnetic female connector 20a. A controller 13 and a magnetic male connector 10b that is connected to the magnetic female connector 20a are arranged inside the watch dial 11, wherein the magnetic male connector 10b and the magnetic female connector 20a are stably connected with each other through a magnetic adsorption way.

Specifically, the smart watch 100 of the present disclosure includes the watch body 10 and the two earphones 20. The watch body 10 consists of the watch dial 11 and the two watch straps 12. The circumferential side 11a of the watch dial 11 is provided with the two spaced installation grooves 11b for accommodating the two earphones 20. The two earphones 20 are inserted into the two installation grooves 11b respectively, and the two earphones 20 partially extend out of the two installation grooves 11b for being easily accessed. The earphone 20 includes the magnetic female connector 20a, while the watch dial 11 is equipped with the controller 13 and the magnetic male connector 10b that is connected to the magnetic female connector 20a. By such magnetic adsorption way, the magnetic male connector 10b and the magnetic female connector 20a can be stably connected with each other, resulting in ensuring that the two earphones 20 can be firmly fixed in the two installation grooves 11b under a non-usage condition, which not only prevents the earphone 20 from being accidental detachment, but also maintains an overall appearance of the smart watch 100. The magnetic male connector 10b and the magnetic female connector 20a are engaged with each other to not only achieve a stable connection of the two earphones 20 through the magnetic adsorption way, but also establish an electrical connection between the two earphones 20 and the watch dial 11. It should be noted that the two earphones 20 of the present disclosure is a Bluetooth earphone 20, which can obtain a Bluetooth connection with a mobile terminal such as a smartphone.

In the present disclosure, it can directly take the earphone 20 without performing complex rotation or unlocking operations, thereby greatly improving usage conveniences thereof, such magnetic adsorption design ensures stability of the earphone 20 under non-usage conditions, resulting in effectively preventing the earphone 20 from being accidental detachment.

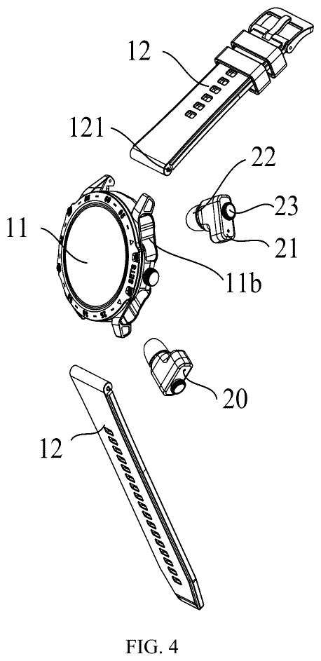

Referring to FIG. 4 to FIG. 7, in an optional embodiment of the present disclosure, each of the two earphones 20 includes a case 21, a rubber stopper 22 connected to a side of the case 21 that faces the installation groove 11b, and a gripping block 23 that is convenient to be gripped and installed on a side of the case 21 that faces away from the installation groove 11b, wherein the gripping block 23 extends out of the installation groove 11b.

Specifically, the earphone 20 includes the case 21, the rubber stopper 22 and the gripping block 23 that are connected together. The case 21 is a main body of the earphone 20 and configured to receive internal components such as circuit boards and speakers to provide protection for the internal components and necessary supports. The case 21 is made of lightweight and sturdy materials to ensure durability and comfort of the earphone 20. The rubber stopper 22 is connected to the side of the case 21 that faces the interior of the installation groove 11b, and is configured to insert into human ears, which is made of soft and hygienic silicone or similar materials. A shape and a size of the in-ear rubber stopper 22 have been carefully designed to ensure a good fit with an ear canal of humans, thereby providing sound insulation and wearing stability. The gripping block 23 is installed on the side of the case 21 that faces away from the rubber stopper 22 (i.e. the side of the case 21 facing outside of the installation groove 11b), and extends out of the installation groove 11b. The gripping block 23 facilitates to grip the earphone 20, which is easy to remove the earphone 20 from the installation groove 11b or insert the earphone 20 into the installation groove 11b. The gripping block 23 is also made of anti-slip materials to increase the stability and comfort for being gripped.

In an optional embodiment of the present disclosure, the gripping block 23 is cylindrical, and a plurality of protrusions 231 is uniformly arranged on an outer circumference of the gripping block 23.

Specifically, the embodiment further refines and optimizes the gripping block 23 of the earphone 20 to enhance the stability and comfort of gripping the earphone 20. The shape of the gripping block 23 is cylindrical, which not only facilitates users to grip the earphones 20, but also adds a certain degree of smoothness and modernity visually. More importantly, there are the plurality of protrusions 231 that is uniformly arranged on the outer periphery of the gripping block 23. The plurality of protrusions 231 can be in the form of dots, strips, or other shapes so that a main function is to increase a friction between fingers of users and the gripping block 23, thereby preventing the earphone 20 from slipping off during the grip process.

In an optional embodiment of the present disclosure, the case 21 includes a first main portion 211 and a second main portion 212 connected to each other, both the first main portion 211 and the second main portion 212 extending from an outer circumference of the watch dial 11 to a middle of the watch dial 11, wherein a length of the first main portion 211 that extends from the outer circumference of the watch dial 11 to the middle of the watch dial 11 is greater than that of the second main portion 212 that extends from the outer circumference of the watch dial 11 to the middle of the watch dial 11.

Specifically, in the embodiment, the case 21 is composed of the first main portion 211 and the second main portion 212 connected to each other. The first main portion 211 and the second main portion 212 both extend from the outer circumference of the watch dial 11 to the middle of the watch dial 11, but with different extension lengths thereof. The extension length of the first main portion 211 is greater than that of the second main portion 212, such design can increase a contact area when the earphone 20 is inserted into the installation groove 11b, resulting in reducing a probability of the earphone 20 falling out of the installation groove 11b. The first main portion 211 receives main electronic components of the earphones 20, such as speakers, microphones and batteries. As the first main portion 211 extends farther, when the earphone 20 is inserted into the installation groove 11b, this part will first contact a corresponding structure of the installation groove 11b, thereby playing a guiding and positioning role thereof. The second main portion 212 extends relatively short and is connected to the first main portion 211, thereby ensuring an overall structural stability of the earphone 20. Due to a shorter length that the second main portion 212 extends along the watch dial 11, when the earphone 20 is inserted into the installation groove 11b, this part will later contact the installation groove 11b, resulting in further stabilizing the earphone 20. The gripping block 23 is arranged on the first main portion 211. As most of a weight of the earphone 20 is concentrated on the first main portion 211, the gripping block 23 that is arranged on the first main portion 211, which not only can conform to mechanical principles, but also can enhance the comfort and convenience of the user during using the earphone 20. Based on a distribution of the weight of the earphones 20, the gripping block 23 is clearly arranged on the side of the first main portion 211 that is away from the watch dial 11. In this way, the gripping block 23 is provide to naturally balance the weight of the earphones 20, so that a more balanced grip force can be obtained during gripping the gripping block 23.

When the earphone 20 is needed to be removed or inserted, it only need to easily grip the gripping block 23 that is arranged on the first main portion 211 by fingers of users. Due to a reasonable position that the gripping block 23 is arranged so that it can balance the weight of the earphones 20, which can feel a more stable and comfortable grip experience during operation.

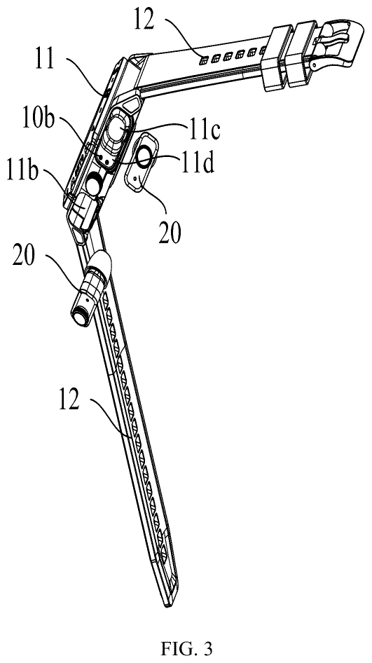

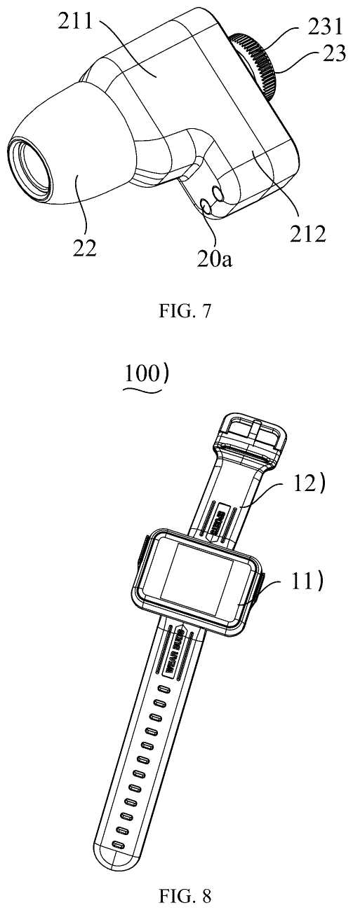

Referring to FIG. 3 and FIG. 7, in an optical embodiment of the present disclosure, each of the two installation grooves 11b includes a first cavity 11c and a second cavity 11d interconnected with each other, the first cavity 11c configured to receive the first main portion 211 therein, and the second cavity 11d configured to receive the second main portion 212 therein.

Specifically, in the embodiment, the first cavity 11c is configured to accommodate the first main portion 211 of the earphone 20. As the first main portion 211 typically contains the main electronic components of the earphone 20, such as a speaker, a microphone and a battery, a shape and a size of the first cavity 11c need to be matched to ensure that the earphone 20 can be securely placed therein. The second cavity 11d is configured to accommodate the second main portion 212 of the earphone 20. The second main portion 212 is shorter compared with the first main portion 211, so that a shape and a size of the second cavity 11d also need to be adjusted accordingly. The second cavity 11d is connected to the first cavity 11c so that a continuous channel is formed therebetween, thereby easily inserting and removing the earphone 20.

Referring to FIG. 3 and FIG. 7 again, in an optical embodiment of the present disclosure, the magnetic female connector 20a is arranged inside the second main portion 212 and extends out of the second main portion 212, while the magnetic male connector 10b extends out of the second cavity 11d and abuts against the magnetic female connector 20a.

In the embodiment, the magnetic female connector 20a is installed inside the second main portion 212 of the earphone 20 and is exposed to the outside from the second main portion 212 for easily engaging with the magnetic male connector 10b. The magnetic male connector 10b is installed in the second cavity 11d of the smart watch 100 and corresponding to the magnetic female connector 20a. When the earphone 20 is inserted into the smart watch 100, the magnetic male connector 10b comes into contact with the magnetic female connector 20a, thereby achieving a connection between the earphone 20 and the smart watch 100.

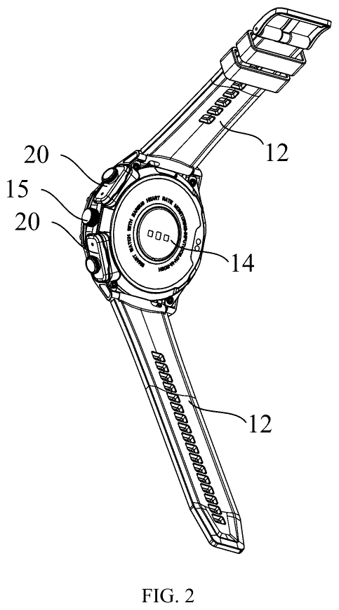

Referring to FIG. 2, in an optical embodiment of the present disclosure, an electrocardiogram detection module 14 is arranged within the watch dial 11 and configured to contact skins of human bodies.

Specifically, in the embodiment, the electrocardiogram detection function is provided to increase a health monitoring capability of the smart watch 100. By designing the electrocardiogram detection module 14 on the watch dial 11, the electrocardiogram detection module 14 can come into contact with skins of users, thereby achieving real-time monitoring and analysis of a heart rate of users. The electrocardiogram detection module 14 is usually arranged at a bottom of the watch dial 11 for being easily contact with wrist skins of users. A shape of the electrocardiogram detection module 14 can be adjusted according to an overall design of the watch dial 11 to ensure that the electrocardiogram detection module 14 can fully contact the skin without affecting the wearing comfort of users. A surface of the electrocardiogram detection module 14 is made of soft and skin friendly materials to ensure good contact with the user's skin. At the same time, the material should also have good conductivity to accurately transmit electrocardiogram signals. When the smart watch 100 is worn, the electrocardiogram detection module 14 will be in close contact with the wrist skin of users. Through internal sensors, the electrocardiogram detection module 14 can collect the electrocardiogram signals of users in real time.

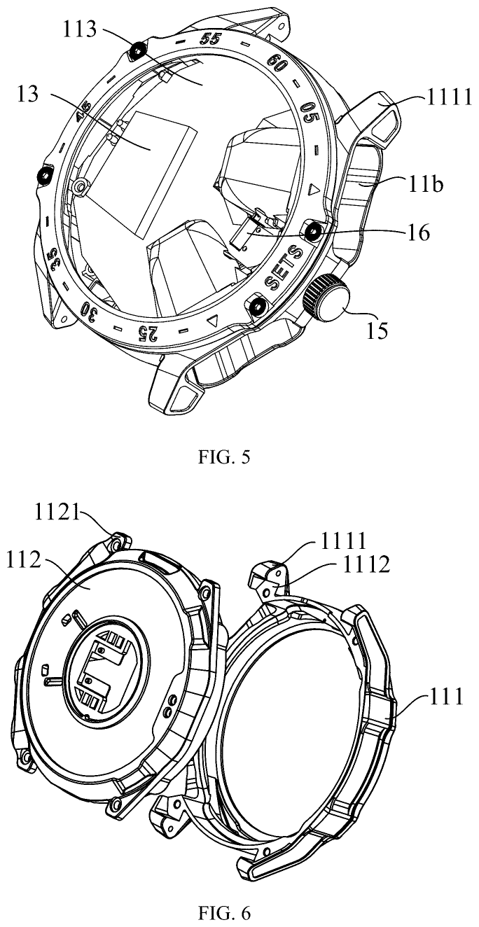

Referring to FIG. 5 and FIG. 6, in an optical embodiment of the present disclosure, the watch dial 11 includes a front housing 111 and a back housing 112 assembled to the front housing 111 so that a first receiving room 113 is formed between the front housing 111 and the back housing 112 and configured to receive the controller 13 therein. And then, the watch dial 11 further includes a knob 15, and a control switch 16 arranged in the first receiving room 113 and connected to the controller 13, wherein the knob 15 is inserted from the outside of the front housing 111 and the back housing 112 into the first receiving room 113, and connected to the control switch 16. The control switch 16 is connected to the controller 13.

Specifically, the watch dial 11 of the embodiment is assembled by the front housing 111 and the back housing 112, resulting in forming the first receiving room 113 that accommodates the controller 13 and other components through assembling the front housing 111 and the back housing 112. The watch dial 11 also includes the knob 15 and the control switch 16. The knob 15 are installed on the outside of the front housing 111 or the back housing 112, so that it can be easily operated by rotating or pressing the knob 15 and the control switch 16. The knob 15 is connected to the control switch 16 through inserting a portion of the knob 15 into the first receiving room 113, thereby achieving communication between user operation and the internal controller 13. The control switch 16 is located in the first receiving room 113 and connected to the controller 13. It triggers different control commands based on an operation of the knob 15, such as adjusting a time, and switching function modes etc. An assembly process of the front housing 111 and the back housing 112 needs to ensure stability and sealing of the overall structure, which can be carried out using methods such as a screw fixation and a buckle connection. Both the front housing 111 and the back housing 112 need to be made of materials that have good wear resistance, corrosion resistance and impact resistance, which can be made of stainless steel, aluminum alloy and plastic, etc.

Referring to FIG. 6, in an optical embodiment of the present disclosure, a pair of first protruding ears 1111 is spaced apart on opposite sides of the front housing 111 along the circumferential direction of the front housing 111, and the two watch straps 12 are respectively connected to the pair of first protruding ears 1111 through a rotating shaft 12 thereof.

Specifically, the embodiment of the present disclosure further optimizes a connection method of the watch strap 12 of the smart watch 100, by providing the rotating shaft 121 to connect the watch strap 12. By setting the pair of first protruding ears 1111 spaced apart on opposite sides of the front housing 111 along the circumferential direction of the front housing 111, and connecting the watch strap 12 to the pair of first protruding ears 1111 through the rotating shaft 121, thereby obtaining a flexible rotation between the watch strap 12 and the watch dial 11, and improving the wearing comfort and convenience thereof. There are the pair of first protruding ears 1111 spaced apart on opposite sides of the front housing 111 along the circumferential direction of the front housing 111, which serve as a basis for connecting the watch strap 12 and ensure that the watch strap 12 can be stably fixed on the front housing 111. The watch strap 12 is connected to the pair of first protruding ears 1111 through the rotating shaft 121. The rotating shaft 121 is a slender cylindrical component, with two ends being inserted into holes of the pair of first protruding ears 1111. By providing the rotating shaft 121, the watch strap 12 can rotate around the front housing 111 to a certain extent, which can adjust an angle of the watch strap 12 according to requirements during wearing the smart watch 100, resulting in a more comfortable wearing experience thereon.

Referring to FIG. 6 again, in an optical embodiment of the present disclosure, each of the pair of first protruding ears 1111 includes a third cavity 1112, and the back housing 112 includes a second protruding ear 1121 arranged inside the third cavity 1112.

Specifically, the embodiment further optimizes the assembly and fixing method of the front housing 111 and the back housing 112. By setting the third cavity 1112 on each first protruding ear 1111 and designing a corresponding second protruding ear 1121 on the back housing 112, a more stable and precise assembly between the front housing 111 and the back housing 112 is achieved. This design not only improves the structural stability of the smart watch 100, but also ensures the safety and reliability of internal components thereof.

During the assembly process, the second protruding ear 1121 of the back housing 112 is first aligned with the third cavity 1112 that is arranged on the first protruding ear 1111 of the front housing 111, and then the back housing 112 is gently pushed towards the front housing 111 until the second protruding ear 1121 is fully inserted into the third cavity 1112. Once the second protruding ear 1121 is fully inserted into the third cavity 1112, in order to further enhance the fixation stability thereof, some locking structures can be set between the third cavity 1112 and the second protruding ear 1121, and screws can be used to pass through the front housing 111 and the back housing 112 to completely fix the front housing 111 and the back housing 112.

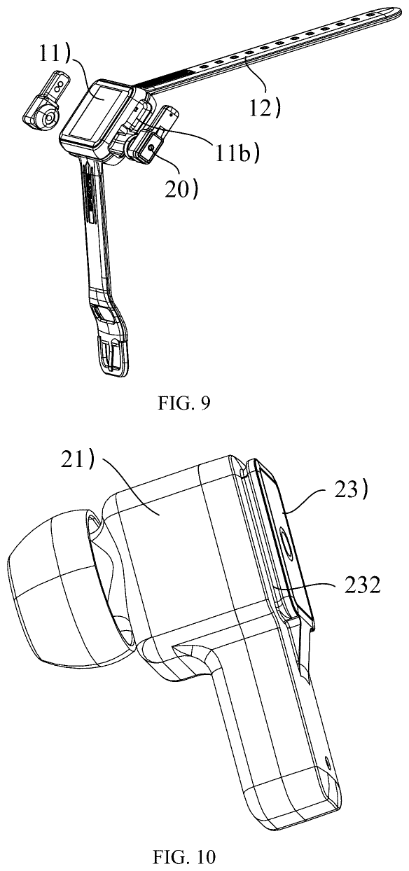

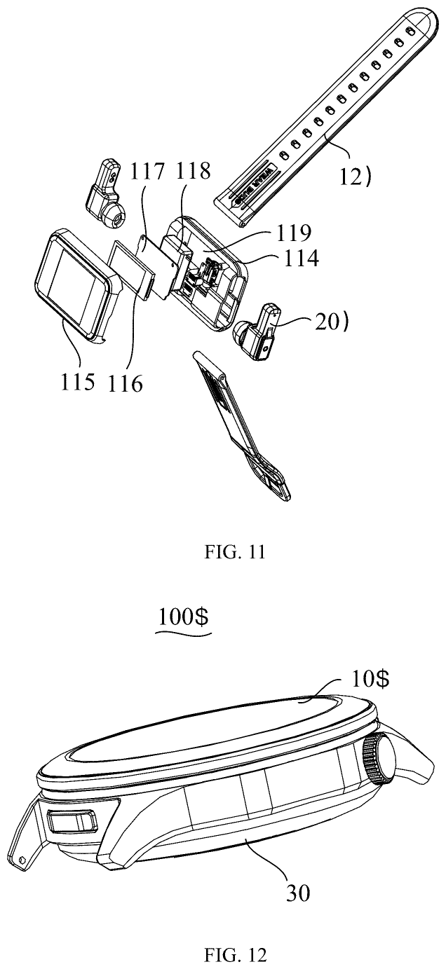

Referring to FIG. 8 to FIG. 11, a smart watch 100′ according to a second embodiment of the present disclosure is provided. The smart watch 100′ of the second embodiment has a similar structure and functions to the smart watch 100 of the first embodiment, a difference is that the watch dial 11′ of the second embodiment is square, and the two earphones 20′ are respectively arranged on opposite sides of the watch dial 11′.

Specifically, in the embodiment, the watch dial 11′ of the smart watch 100′ is designed to be square, which contrasts sharply with the commonly circular watch dial that is seen in the market. The square watch dial 11′ not only provides a different visual experience for users, but also can bring more flexibility and innovation to screen layouts and interface designs. The two watch straps 12′ are respectively set on both sides of the watch dial 11′ along a width direction thereof, and the two installation grooves 11b′ configured to accommodate the two earphones 20′ are respectively set on both sides of the watch dial 11′ along a length direction thereof. The two watch straps 12′ are located on both sides of the watch dial 11′ along the width direction thereof, such design is ergonomically to evenly distribute a pressure of the watch that applies to the wrist, thereby ensuring comfort for a long-term wear. This design also makes the watch strap 12′ be easier to be adjusted so as to fit different wrist sizes of users, resulting in improving the wearing stability thereof. The installation grooves 11b′ for the earphones 20′ are located on both sides of the watch dial 11′ in the length direction thereof, which is away from the watch strap 12′, thereby avoiding an impact of storing the earphone 20′ to the wearing comfort of the smart watch 100′. At the same time, this layout also reduces an interference of the earphones 20′ to the watch strap 12′ and the wrist during installation and removal of the earphone 20′.

In an optical embodiment of the present disclosure, a strip 232 is provided at a position where the gripping block 23′ is connected to the case 21′, and configured to insert users' fingertips thereinto.

Specifically, in the embodiment, by providing the strip 232, users can easily insert their nails, so as to conveniently remove the earphones 20′ from the installation groove 11b′. This design avoids users from using additional tools or additional forces to remove the earphones 20′, which is highly convenient thereof. The strip 232 provides a clear guidance for the user's fingertips, so as to more accurately locate the installation groove 11b′ when removing the earphones 20′ Due to provide the strip 232, the present disclosure can set the size of the gripping block 23′ to be smaller, thereby increasing an aesthetic appeal of the entire watch dial 11′ and preventing a protruding part of the earphone 20′ that extends out of the installation groove 11b′ from being too protruded. In summary, by setting the strip 232, the design of the smart watch can obtain a balance between the aesthetics and a practicality. This design not only enhances the overall aesthetics of the watch dial 11′, but also effectively reduces the protrusion of the earphone 20′ protruding from the installation groove 11b′, thereby providing a more comfortable and convenient wearing experience thereof.

In an optical embodiment of the present disclosure, the watch dial 11′ further includes a bottom housing 114, a cover 115, a touch screen 116, a control board 117 and a battery module 118, the bottom housing 114 and the cover 115 engaged with each other to form a second receiving room 119 for accommodating all the touch screen 116, the control board 117 and the battery module 118 therein, wherein the control board 117 is electrically connected to both the touch screen 116 and the battery module 118.

Specifically, in the embodiment, the bottom housing 114 is the bottom structure of the smart watch 100′, and the cover 115 covers on the bottom housing 114 and is tightly assembled with the bottom housing 114 to form an external protective layer of the smart watch 100′. The control board 117 is a brain of the smart watch 100′ and is responsible for processing various instructions and data. The control board 117 is electrically connected to components such as the touch screen 116 and the battery module 118 to perform information transmission and processing. The battery module 118 provides continuous power supply for the smart watch 100′. The touch screen 116 is a main interface for interaction between the smart watch 100 and a user. Users can perform various operations through the touch screen 116, such as checking a time, a date, receiving notifications, and controlling music playback etc.

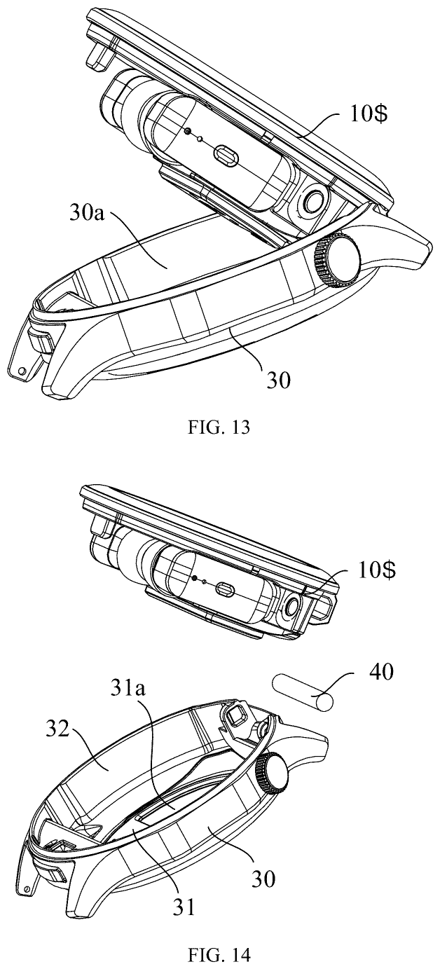

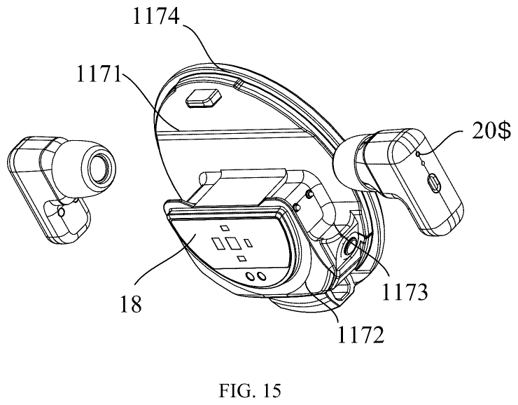

Referring to FIG. 12 to FIG. 15, a smart watch 100″ according to a third embodiment of the present disclosure is provided. In the third embodiment, the smart watch 100″ includes a watch body 10″ and a flipping cover 30 rotatably connected to the watch body 10″. The watch body 10″ includes a base 17 and two earphones 20″ installed on the base 17. The flipping cover 30 includes a third receiving room 30a configured to accommodate the watch body 10″ therein, and the flipping cover 30 rotates relative to the watch body 10″ to close the two earphones 20″ into the third receiving room 30a.

Specifically, in the embodiment, the watch body 10″ is a core part of the smart watch 100″ and includes the base 17 and the two earphones 20″ installed on the base 17. The base 17 receives necessary electronic components such as the control board and the battery therein. The two earphones 20″ can be detachably installed on the base 17 so that the two earphones 20″ can be removed from the base 17 or put back into the base 17 for being stored according to actual requirements. The flipping cover 30 is an innovative element of the smart watch 100″ of the present disclosure, which is rotatably connected to the base 17 of the watch body 10″. The third receiving room 30a of the flipping cover 30 is configured to cover on the watch body 10″ when the flipping cover 30 is closed, to protect the two earphones 20″ in the third receiving room 30a. When the two earphones 20″ is used, the flipping cover 30 is easily rotated to be opened, thereby exposing the two earphones 20″ for being accessed. When the two earphones 20″ isn't used, the flipping cover 30 is rotated to be closed, so as to completely cover the two earphones 20″ in the third receiving room 30a. Such design not only protects the earphones 20″ from external environmental damage, but also makes the smart watch 100″ more concise and unified in appearances thereof.

In an optical embodiment of the present disclosure, one end of the base 17 is connected to one end of the flipping cover 30 through a rotation shaft 40, and the other end of the base 17 is fastened to the other end of the flipping cover 30.

Specifically, in the embodiment, the rotation shaft 40 is included in the smart watch 100″ and is a key component that connects the base 17 and the flipping cover 30, which allows the flipping cover 30 to rotate relative to the base 17. When the flipping cover 30 is closed, the other end of the base 17 is connected to the other end of the flipping cover 30 through a buckle to ensure the stability of the smart watch 100″ in the closed state. A snap structure can be a snap element, a magnetic element, or other types of connection structures. The snap structure is provided to ensure the stability of the flipping cover 30 in the closed state, thereby avoiding damage or functional failure caused by accidentally opening the flipping cover 30.

In an optical embodiment of the present disclosure, the base 17 includes a cover plate 1171 and a protruding shell 1172, and two slots 1173 formed between the cover plate 1171 and the protruding shell 1172 and configured to receive the two earphones 20″ therein.

Specifically, in the embodiment, the base 17 is composed of the cover plate 1171 and the protruding shell 1172. The two slots 1173 are formed between the cover plate 1171 and the protruding shell 1172 for receiving the two earphones 20″ therein, respectively. This design not only provides a storage space for the two earphones 20″, but also protects the two earphones 20″ from being damaged and makes the smart watch 100″ more compact and orderly in a structure thereof. The cover plate 1171 is one part of the base 17 and arranged on a side of the protruding shell 1172. The protruding shell 1172 is the other part of the base 17, and connected to the cover plate 1171 to form an outward protruding structure thereof. The protruding shell 1172 is designed to need to take into account the shape and the size of the earphones 20″ to ensure that the earphones 20″ can be securely placed in the slots 1173.

In an optical embodiment of the present disclosure, a periphery of the cover plate 1171 protrudes outwardly to form a positioning step 1174 thereof, and the positioning step 1174 covers on the third receiving room 30a of the flipping cover 30.

Specifically, in the embodiment, the periphery of the cover plate 1171 is designed to protrude outwardly, thereby forming the positioning step 1174 thereof. When the flipping cover 30 is closed, the positioning step 1174 will cover on an opening edge of the third receiving room 30a, to form a tight contact surface thereof. Such tight contact not only prevents external substances such as dusts and moistures from entering the interior of the smart watch 100″, but also increases stability the smart watch 100″ during the closed state.

In an optical embodiment of the present disclosure, the flipping cover 30 includes a bottom wall 31 and a flange 32 surrounding around the bottom wall 31, wherein the bottom wall 31 and the flange 32 cooperatively form the third receiving room 30a, a through-hole 31a formed on the bottom wall 31, wherein the watch body 10″ further includes a display screen 18 exposed from the through-hole 31a to the outside.

Specifically, in the embodiment, the flipping cover 30 is a lid consisting of the bottom wall 31 and the flange 32. The flange 32 is a part that extends outwardly around an edge of the bottom wall 31, and together with the bottom wall 31, to form the third receiving room 30a. The bottom wall 31 is designed with the through-hole 31a, a size and a shape of the through-hole 31a are precisely calculated to ensure that the display screen 18 can be fully exposed out of the through-hole 31a, thereby ensuring that information on the display screen 18 can be clearly seen during using the smart watch 100″. At the same time, it does not affect closing and sealing performances of the flipping cover 30. The flipping cover 30 is designed that the smart watch 100″ is more compact, without unnecessary space occupation, and also more convenient to be carried.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

1. A smart watch comprising:
a watch body comprising a watch dial and two watch straps connected to the watch dial, two installation grooves arranged on a side of the watch dial;
two earphones respectively inserted into the two installation grooves and extending out of the two installation grooves; and wherein
each of the two earphones comprises a magnetic female connector, wherein a controller and a magnetic male connector that is connected to the magnetic female connector are arranged inside the watch dial, and the magnetic male connector and the magnetic female connector are stably connected with each other through a magnetic adsorption way.

2. The smart watch as claimed in claim 1, wherein each of the two earphones comprises a case, a rubber stopper connected to a side of the case that faces the installation groove, and a gripping block that is convenient to be gripped by users and installed on a side of the case that faces away from the installation groove, wherein the gripping block extends out of the installation groove.

3. The smart watch as claimed in claim 2, wherein the gripping block is cylindrical, and a plurality of protrusions is uniformly arranged on an outer circumference of the gripping block.

4. The smart watch as claimed in claim 2, wherein the case comprises a first main portion and a second main portion connected to each other, both the first main portion and the second main portion extending from an outer circumference of the watch dial to a middle of the watch dial, wherein a length of the first main portion that extends from the outer circumference of the watch dial to the middle of the watch dial is greater than that of the second main portion that extends from the outer circumference of the watch dial to the middle of the watch dial.

5. The smart watch as claimed in claim 4, wherein each of the two installation grooves comprises a first cavity and a second cavity interconnected with each other, the first cavity configured to receive the first main portion therein, and the second cavity configured to receive the second main portion therein.

6. The smart watch as claimed in claim 5, wherein the magnetic female connector is arranged inside the second main portion and extends out of the second main portion, while the magnetic male connector extends out of the second cavity and abuts against the magnetic female connector.

7. The smart watch as claimed in claim 1, wherein an electrocardiogram detection module is arranged within the watch dial and configured to contact skins of human bodies.

8. The smart watch as claimed in claim 1, wherein the watch dial comprises a front housing and a back housing assembled to the front housing so that a first receiving room is formed between the front housing and the back housing and configured to receive the controller therein.

9. The smart watch as claimed in claim 8, wherein the watch dial further comprises a knob, and a control switch arranged in the first receiving room and connected to the controller, wherein the knob is inserted from the outside of the front housing and the back housing into the first receiving room, and connected to the control switch.

10. The smart watch as claimed in claim 8, wherein a pair of first protruding ears is spaced apart on opposite sides of the front housing along a circumferential direction of the front housing, and the two watch straps are respectively connected to the pair of first protruding ears through a rotating shaft thereof.

11. The smart watch as claimed in claim 10, wherein each of the pair of first protruding ears comprises a third cavity, and the back housing comprises a second protruding ear arranged inside the third cavity.

12. The smart watch as claimed in claim 2, wherein the watch dial is square, and the two earphones are respectively arranged on opposite sides of the watch dial.

13. The smart watch as claimed in claim 12, wherein a strip is provided at a position where the gripping block is connected to the case, and configured to insert users' fingertips thereinto.

14. The smart watch as claimed in claim 12, wherein the watch dial further comprises a bottom housing, a cover, a touch screen, a control board and a battery module, the bottom housing and the cover engaged with each other to form a second receiving room for accommodating all the touch screen, the control board and the battery module therein, wherein the control board is electrically connected to both the touch screen and the battery module.

15. A smart watch comprising:
a watch body comprising a base and two earphones installed on the base; and
a flipping cover rotatably connected to the base; and wherein
the flipping cover comprises a third receiving room configured to accommodate the watch body therein, and the flipping cover rotates relative to the watch body to close the two earphones into the third receiving room.

16. The smart watch as claimed in claim 15, wherein one end of the base is connected to one end of the flipping cover through a rotation shaft, and the other end of the base is fastened to the other end of the flipping cover.

17. The smart watch as claimed in claim 15, wherein the base comprises a cover plate and a protruding shell, and two slots formed between the cover plate and the protruding shell and configured to receive the two earphones therein.

18. The smart watch as claimed in claim 17, wherein a periphery of the cover plate protrudes outwardly to form a positioning step thereof, and the positioning step covers on the third receiving room of the flipping cover.

19. The smart watch as claimed in claim 15, wherein the flipping cover comprises a bottom wall and a flange surrounding around the bottom wall, wherein the bottom wall and the flange cooperatively form the third receiving room, a through-hole formed on the bottom wall, wherein the watch body further comprises a display screen exposed from the through-hole to the outside.
